(19) United States
(12) Patent Application Publication
(10) Pub. No.: US 2021/0388647 A1
(43) Pub. Date: Dec. 16, 2021

(54) INSTALLATION STRUCTURE OF AUXILIARY LOCKING DEVICE FOR HINGED DOOR

(71) Applicant: FILOBE CO., LTD., Gyeongsan-si (KR)

(72) Inventor: Kwang-Seok LEE, Daegu (KR)

(21) Appl. No.: 17/284,780

(22) PCT Filed: Oct. 14, 2018
(86) PCT No.: PCT/KR2018/012073

§ 371 Date: Apr. 14, 2021

(51) Int. Cl. E05C 9/02; E05C 1/00; E05C 1/06

(52) U.S. Cl. CPC E05C 9/02; E05C 1/06; E05C 1/006

(57) ABSTRACT

The present invention relates to an installation structure of an auxiliary locking device for a hinged door, and by operating a rotation lever installed on a door frame separately from a generally used security main locking device, the rotating opening side of the hinged door is vertically attached to the door frame in close contact with the door frame at a number of points in the longitudinal direction, and in order to make it easier to fix and maintain such a tight state. More particularly, the present invention is directed to providing new installation structure of the auxiliary locking device of the hinged door capable of preventing the mutual interference of the driving plate and locking piston, even if the longitudinal installation range of the driving plate is overlapped with the operating range of the locking piston constituting the second locking tool.

### TECHNICAL FIELD

The present invention relates to a structure of auxiliary locking device of a hinged door that can be used as an auxiliary locking device for a hinged door. The auxiliary locking device of the hinged door operates a rotation lever installed on the door frame separately from the main locking device for security that is generally used, so that the rotating and opening side of the hinged door is in close contact with the door frame at a number of points in the longitudinal direction. It is configured to make it easier to maintain a fixed state.

### BACKGROUND ART

Doors for a building entrance with a hinged door structure and various hinged doors installed indoor (referred to as the hinged door in the specification, including a hinged door for entrance and a hinged window) use various locking devices. As a general prior art of the locking device of a hinged door and a hinged window, locking devices with various structures, such as “Locking Device of Hinged Door” in Korean Registration Patent (B1) No. 10-1237681 (Feb. 26, 2013), “Locking Device of Hinged Door” in Korean Utility Model Registration (Y1) No. 20-0271060 (Apr. 9, 2002), and “Locking Device of Hook Direction Changing Type-Hinged Door” in Korean Utility Model Registration (Y1) No. 20-0476646 (Mar. 18, 2015), and the like, are disclosed. As shown in FIGS. 1A to 1C, the locking devices in the prior art are in a locked state when a locking cylinder is installed on a rotating opening side of the hinged door 1 installed on a door frame using a door hinge 1b installed on one side of a door frame 1a moves forward and is inserted into a cylinder pocket 1sa installed to face the door frame 1a (see FIGS. 1B and 2Bb) or are in a unlocked state when the locking cylinder is comes out of the cylinder pocket 1sa and moves backward toward the hinged door 1 (see FIG. 1C). An operation in which the locking cylinder is moves forward or backward from the cylinder pocket 1sa of the locking cylinder is may be performed by a manual rotation operation of a door handle 1h mounted on the hinged door 1 or other various electronic opening and closing devices.

However, since the conventional locking devices are used for security, the locking device only has a structure of maintaining a locked state in which a hinged door is locked on a door frame and performs a locking function at one point of the hinged door in a longitudinal direction of the hinged door as shown in FIG. 1A. As shown in FIG. 2B which is an enlarged transverse sectional view illustrating the locked state in which the hinged door is closed, an operation gap Δg is necessary between the locking cylinder 1s and the cylinder pocket 1sa for smooth operation, and the hinged door is separated from the door frame by a gap when strong wind blows, and thus it is difficult to maintain a good airtight state, and further, it causes rattling and noise.

Further, use of various electronic opening and closing devices as the locking device of a hinged door has been increasing recently. In the case of the electronic opening and closing device (an electronic door lock), when the locked state is released due to external strong electric shock or password exposure, an intrusion path to go inside may be provided, and thus a separate locking device is further required.

In order to solve this problem, the applicant of the present invention devised an auxiliary locking device with a new structure and filed on Aug. 12, 2016 as Korean Patent Application No. 10-2016-0102999 (KR 10-1812303 B1, 2017, 12, 26, Published) According to this application, as shown in the accompanying drawings FIGS. 2a and 2c, as an auxiliary locking device for the hinged door 1 installed between the rotating opening side of the hinged door 1 installed inside the door frame and the door frame 1a using a door hinge 1b installed on one side of the door frame, as shown in the accompanying drawings FIG. 2a to FIG. 8, proposed an auxiliary locking device comprising:

a plurality of close contact guide plates 130 installed on a rotation opening side of the hinged door 1 to be separated from each other in a longitudinal direction.

a plurality of pressure rolls 120 which achieve a pressed-locked state by pulling the rotation opening side of the hinged door 1 toward a door frame 1a when in contact with the close contact guide plate 130 in a state in which the rotation opening side of the hinged door 1 is closed to the door frame 1a and which are installed on the door frame 1a to be separated from each other in a longitudinal direction so that the rotation opening side of the hinged door 1 achieves a uncompressed-locked state on the door frame 1a in a noncontact state with the close contact guide plates 130,

a driving plate 110 installed in a sliding pocket 110a provided in the door frame 1a in the longitudinal direction so that the pressure rolls 120 slidably move toward the door frame 1a in the longitudinal direction and provided with the pressure rolls 120 formed on the front surface thereof to be separated from each other in the longitudinal direction, and

a switching device 100 which induces a longitudinal movement displacement H corresponding to that of the driving plate 110 by being engaged with a first pressure roll 120a of the pressure rolls 120 installed on the driving plate 110 to provide the longitudinal movement displacement H, generates a longitudinal movement displacement H of a second pressure roll 120b induced by the longitudinal movement displacement H of the driving plate 110, and is installed in the door frame 1a to allow the second pressure roll 120b to switch between a contact pressed state position with the close contact guide plates 130 and a noncontact-uncompressed state position through the longitudinal movement displacement H.

In this case, as shown in the accompanying drawings FIG. 2a to FIG. 8, the switching device 100 includes

a housing 10 fixedly installed on the door frame 1a:

a rotatable lever 30 installed in the housing 10 by a first hinge pin 32 to be rotated on a front surface of the housing in the longitudinal direction; a conversion link bar 40 having one end portion connected at a predetermined position between a first hinge pin 32 of the rotatable lever 30 and a rotating end portion by a second hinge pin 40a;

a sliding block 20 connected to the other end portion of the conversion link bar 40 by a third hinge pin 40b and sliding linearly in the housing 10 in the longitudinal direction according to a longitudinal rotation operation of the rotatable lever 30;

a cover plate 50 for covering a rear surface of the housing 10 to limit a displacement of the sliding block 20 caused by the longitudinal rotation operation of the rotatable lever 30 to a longitudinal linear sliding displacement in the housing 10 and including a sliding guide groove 52 for guiding the longitudinal linear sliding displacement and having a hole formed in the longitudinal direction in a size limiting the height of the sliding displacement; and

a slider fork 25 integrated with the sliding block 20, protruding to the outside of the sliding guide groove 52 formed in the cover plate 50, and sliding along the sliding guide groove 52 in the longitudinal direction while being engaged with the first pressure roll 120a.

In this case, unlike the second pressure roll 120b, the first pressure roll 120a is an element engaged with the slider fork 25, not an element which is in contact with the close contact guide plates 130, and thus the name of the element may vary, but functions of the first pressure roll 120a and the second pressure roll 120b of the plurality of pressure rolls 120 may be changed when an installation position of the switching device 100 installed in the door frame 1a is changed, and thus a unified name is used in the present specification, and the pressure rolls 120 may be a cylindrical roller having a touched outer circumferential surface freely rotating about a central portion so that excessive frictional force or frictional noise is not generated in a process of being engaged with the slider fork 25 or in a process of moving while in contact with the close contact guide plate 130.

Further, a rotatable lever releasing blocking unit for blocking a releasing operation of the rotatable lever 30 to rotate the rotatable lever 30 before external force greater than a predetermined strength is applied to the rotatable lever 30 may be additionally provided in the switching device 100 in order for the second pressure roll 120b to maintain a fixed state at a contact pressed state position with the close contact guide plate 130 or a noncontact-uncompressed state position.

In this case, to provide the rotatable lever releasing blocking unit, which is one of the rotatable lever reverse releasing blocking unit, while the rotatable lever 30 composing the switching device 100 rotates upward about the first hinge pin 32 so that the second hinge pin 40a is positioned above the first hinge pin 32, the third hinge pin 40b, the first hinge pin 32, and the second hinge pin 40a are sequentially disposed in a neutral state N.A. (referring to FIG. 7) to be disposed in a straight line inclined upward, and a sliding guide groove upper limit line U.L. is set at a position limiting the additional free upward movements of the sliding block 20 and the slider fork 25 before the neutral state N.A. A further upward movement of the sliding block and the slider fork are elastically received by elastic pressure deformation of an upper region 50b of the cover plate 50 induced by an upward displacement exceeding an upper line of the sliding guide groove while the rotatable lever 30 rotates upward to reach the neutral state N.A., and the sliding block 20 and the slider fork 25 connected to the link bar 40 are moved slightly downward using the third hinge pin 40b by elastic recovery deformation of the upper region 50b of the elastically pressed cover plate 50 in a section in which the rotatable lever is additionally rotated upward to a vertically upright state beyond the neutral state. A sliding guide groove upper limit line U.L. position of the sliding guide groove 52 may be set to limit a reverse operation (downward rotation and downward movement) of the rotatable lever 30, the sliding block 20, and the slider fork 25 integrated with the sliding block 20 until external force strong enough for elastic pressure deformation of the upper region 50b of the cover plate 50 to be re-performed according to slight upward movement of the sliding block and the slider fork for recovering slight downward movement is applied to the rotatable lever 30.

Further, to provide a second rotatable lever releasing blocking unit, which is another one of the rotatable lever releasing blocking units, while the rotatable lever 30 composing the switching device 100 rotates downward about the first hinge pin 32 to a vertically downward state so that the second hinge pin 40a is positioned below the first hinge pin 32, the first hinge pin 32, the second hinge pin 40a, and the third hinge pin 40b are disposed downward sequentially in a triangular structure, and a sliding guide groove lower limit line L.L. is set at a position limiting additional free upward moving of the sliding block 20 and the slider fork 25 before the vertically downward state. A further downward movement of the sliding block 20 and the slider fork 25 are elastically received by elastic pressure deformation of the lower region 50a of the cover plate 50 induced by an upward displacement exceeding the sliding guide groove lower limit line L.L. while the rotatable lever 30 rotates downward to reach the vertically downward state, and a lever downward moving unit and a lever recovery unit may be provided between the housing and the rotatable lever to induce forcible further slight downward movement and recovery of the rotatable lever 30 in a downward rotation section until the rotatable lever 30 reaches the vertically downward state beyond the sliding guide groove lower limit line L.L. state in which free downward movement of the sliding block 20 and the slider fork 25 is limited, and therefore, a reverse operation (upwardly rotating and upwardly moving) of the rotatable lever 30, the sliding block 20, and the slider fork 25 integrated with the sliding block 20 is limited until elastic pressure deformation of the cover plate-lower region 50a is re-performed by the forcible further slight downward movement of the rotatable lever 30 by the rotatable lever 30 rotated from the lever recovery unit through the lever downward moving unit in a reverse direction.

In this case, as shown in the accompanying drawing FIG. 5, the lever downward moving unit includes a catching protrusion 10s protruding from a side wall of the housing 10; a catching projection 30sa formed on an entrance of a catching protrusion 10s which is concavely formed to correspond to the catching protrusion 10s in a side surface of the rotatable lever 30; and a long hole portion 30e which is a hinge hole of the rotatable lever 30 to which the first hinge pin 32 is fastened to allow the rotatable lever 30 to move downward when the catching projection 30sa comes out of a lower end portion of the catching protrusion 10s and includes a vertical gap for the first hinge pin 32. And the lever recovery unit includes an elastic recovery deformation of the cover plate-lower region 50a; and a catching protrusion expanded mounting portion 30se formed in the catching groove 30s to receive elastic recovery deformation of the cover plate-lower region 50a.

In the above prior invention, by rotating the rotatable lever 30 upward while the locking device for the hinged door is installed on one side of the door frame as shown in the perspective view of the door frame side of FIG. 3A, the driving plate 110 on which the first pressing roll 120a is installed is slid in the longitudinal direction inside the sliding pocket 110a provided in the longitudinal direction on the door frame 1a to provide a longitudinal movement displacement (H), therefore by generating the longitudinal movement displacement (H) of the remaining second pressing roll 120b induced by the longitudinal movement displacement (H) of the driving plate 110, it makes possible to implement the switching operation states shown in a cross-sectional view of the accompanying drawings FIGS. 2C and 2D of the present application specification.

Thus, as shown in FIG. 3b showing all of a plurality of close contact guide plates 130 installed longitudinally spaced apart from each other in the rotating opening side of the door frame 1a and the hinged door 1 in a longitudinal section, through the longitudinal movement displacement (H) of the second pressing roll 120b, a plurality of close contact guide plates 130 provided on the rotating opening side of the hinged door 1 to engage with the second pressing roll are pulled toward the door frame (Pull), and a switching operation from the non-contact non-pressurized state (un-compressed/locked state) position to the contact pressurized state (compressed/locked state) position occurs.

However, in the case of a plurality of doors having a security function, in addition to a basic locking tool by a locking cylinder is and a cylinder pocket 1sa opened by the door handle 1h, as shown in the accompanying drawings FIGS. 9A and 9B, it is common to adopt a multi-locking system with additional locking tools 1ph, 1p, 1pv. In particular, a special structure is adopted in the case of the additionally provided second locking tools 1ph, 1p, 1pv. According to the special structure, a piston acceptor 1pv that receives the locking piston 1p operated by the locking dial 1ph and keeps the door closed, is formed as close as possible to the door frame 1a side. Therefore, it makes sure that the locking piston 1p is not easily released by a simple exterior operation. In this case, the operating range of the locking piston 1p constituting the second locking tool 1ph, 1p, 1pv is overlapped with the longitudinal installation range of the drive plate 110 provided with a plurality of second pressing rolls 120b, and so that the operation of the drive plate 110 and locking piston 1p causes mutual interference. On the contrary, in order to avoid the mutual interference, when the installation range of the driving plate 110 is limited to the upper region of the locking piston 1p as shown in FIG. 9b, such a problem arises that the switching operation to the contact pressurized state (compressed/locked state) position with respect to the lower portion of the hinged door 1 is performed incompletely.
(Patent Document 0001) Korean Patent Publication (B1)10-1237681 (2013.02.26.)
(Patent Document 0002) Korean Utility Model Publication (Y1)20-0271060 (2002.04.09.)
(Patent Document 0003) Korean Utility Model Publication (Y1)20-0476646 (2015.03.18.)

### Technical Problem

The present invention is to solve the problems of the prior invention of the applicant of the present application described above. It is a technical problem of the present invention to provide an installation structure of an auxiliary locking of the hinged door, wherein the auxiliary locking of the hinged door that can be used as an auxiliary locking device that can control the gap between the hinged door and the door frame in order to provide a better confidentiality after the locking state is implemented by the general security main locking device in the closed state of the hinged. More particularly, the present invention is directed to providing new installation structure of the auxiliary locking device of the hinged door capable of preventing the mutual interference of the driving plate and locking piston, even if the longitudinal installation range of the driving plate 110 is overlapped with the operating range of the locking piston 1p constituting the second locking tool 1ph, 1p, 1pv, as shown in the cross-sectional view of FIG. 10A (section d-d′ in FIG. 9A), FIG. 10B (section e-e′ in FIG. 9A), and FIG. 10C (section f-f′ in FIG. 9A).

In addition, when a fastening piece is used to securely fix the cylinder pocket 1sa that is locked by engaging with the locking cylinder is to the side of the door frame 1a, an installation structure in which this fastening piece does not interfere with the longitudinal movement of the drive plate 110, is required.

### Technical Solution

In order to solve the above-described technical problem, the present invention provides an installation structure of an auxiliary locking device for a hinged door provided in order to realize a close contact state of a door frame of a hinged door provided with two or more locking tools as a main locking device for security, wherein the auxiliary locking device comprises:

a plurality of close contact guide plates that are installed longitudinally and spaced apart from the rotating opening side of the hinged door;

a plurality of pressure rolls provided longitudinally spaced apart from the door frame side so that in a state in which the rotating opening side of the hinged door is closed on the door frame side, in a contact state with the close contact guide plates, the rotating opening side of the hinged door is pulled toward the door frame side, thereby implementing a compressed locked state, and so that in a non-contact state with the close contact guide plates, an uncompressed locked state of the rotating opening side of the hinged door against the door frame side is implemented:

a driving plate installed in a sliding pocket provided in a longitudinal direction on the door frame side so that the pressure rolls can be installed to be slidably movable in a longitudinal direction from the side of the door frame, and provided so that the pressure rolls are spaced apart in the longitudinal direction on the front side; and

a switching device installed in the door frame so that the second pressure roll switches between a contact compressed state position with the close contact guide plate and a non-contact uncompressed state position through a longitudinal movement displacement, so that can induce a corresponding longitudinal movement displacement of the driving plate by providing a longitudinal movement displacement by engaging with at least one first pressure roll among the pressure rolls installed on the driving plate, and so that can generate the longitudinal movement displacement of the remaining second pressure roll induced by the longitudinal movement displacement of the drive plate;

wherein an auxiliary locking device installation structure for a hinged door in which the auxiliary locking device is installed between the rotating opening side of the hinged door and the door frame side, is characterized in that,

as an opening and closing device for a hinged door, the driving plate is respectively disposed in the upper section and in the lower section of the area in which the first locking tool and the second locking tool are installed, which are provided as the main locking device for security between the rotating opening side of the hinged door and the door frame side, and sliding pockets at the upper and lower portions are installed separately in the longitudinal direction on the side of the door frame in order to accommodate the driving plates, respectively,

a connecting plate is provided as a connecting means installed so as to reciprocate between the upper and lower sliding pockets and interconnect the upper and lower drive plates that are separately installed up and down, wherein the connecting plate comprising an upper connecting plate connected to the lower end of the upper driving plate, and a lower connecting plate connected to the upper end of the lower driving plate and connected so that the upper connecting plate is not separated in the longitudinal direction but can be separated only in the front-rear direction,

a base plate is provided, wherein the base plate being installed between the upper and lower sliding pockets separated and separated to each other to support the bottom surface of the connecting plate and to guide the vertical movement of the connecting plate, and

a cover plate is provided on an upper surface of the base plate to be spaced apart from each other by a height exceeding the thickness of the connecting plate in order to form an operating space allowing the connecting plate to move in the longitudinal direction,

wherein a pocket installation groove in which a cylinder pocket accommodating a locking cylinder constituting the first locking tool is installed is provided on the upper surface of the cover plate, and

wherein the cover plate and the connecting plate are provided with locking piston through holes, respectively, so that the lateral operating range of the locking piston constituting the second locking tool can reach the base plate region.

Here, in order to be spaced apart by a height exceeding the thickness of the connecting plate to be installed on the upper surface of the base plate to form an operating space that enables longitudinal movement of the connecting plate, it is preferable to include a spacer provided to support a part of the upper surface of the base plate and a part of the bottom surface of the cover plate, wherein the spacer may be integrally protruded from the upper surface of the base plate, alternatively, the spacer may be integrally protruded from the lower surface of the cover plate.

### Advantageous Effects

According to the present invention, after the locking state is implemented by a general locking device in the closed state of the hinged door, an auxiliary locking device capable of tightly controlling the gap between the hinged door and the door frame at a plurality of points in the longitudinal direction, can be provided over the entire length direction of the hinged door without any limitation or interference in the range of installation and operation of the various locking tools used in the multi-locking system. Thereby, an effect of achieving a better airtight state is provided, and further, even when a strong wind blows, the hinged door is not rattled and does not cause noise.

### DESCRIPTION OF DRAWINGS

FIG. 1A is a front view showing a hinged door installed in a door frame using a door hinge installed on one side of the door frame, FIG. 1B is a cross-sectional view taken along line a-a′ of FIG. 1A in a state of being locked by a general door handle, and FIG. 1C is a cross-sectional view taken along line a-a′ of FIG. 1A in a state of being unlocked by a door handle.

FIG. 2A is a front view showing a state in which a locking device of a hinged door according to the present invention is installed between a door frame and a rotating opening side of the hinged door installed in the door frame using a door hinged installed on one side of the door frame, FIG. 2B is a cross-sectional view taken along line a-a′ of FIG. 2A in a locked state, and FIG. 2C is a cross-sectional view taken along line b-b′ of FIG. 2A in a uncompressed/locked state, and FIG. 2D is a cross-sectional view taken along line b-b′ of FIG. 2A in a compressed/locked state.

FIG. 3A is a view showing an operation state in which, when the locking device of a hinged door according to the present invention is installed on one side of the door frame, an operating plate with a pressure roll slides from a door frame side in a longitudinal direction by rotating a rotatable lever in a vertical direction so as to switch a uncompressed/locked state to a compressed/locked state, and FIG. 3B is a view showing an operation state in which a plurality of close contact guide plates, which are installed on a rotating opening side of the hinged door to be separated from each other in the longitudinal direction, are pulled toward the door frame side when the operation plate with the pressure roll shown in FIG. 3A slides from the door frame side in the longitudinal direction so as to switch from the uncompressed/locked state to the pressed/locked state.

FIGS. 4 to 8 are exploded perspective views showing processes of an operation state of the switching device, which is a switching device composing the locking device of a hinged door according to the present invention, installed on the door frame to switch a pressure roll between a contact-compressed state position with the close contact guide plate and a noncontact-uncompressed state position through a longitudinal movement displacement.

FIGS. 9A and 9B are views for explaining a problem that occurs when an auxiliary locking device for a hinged door according to the prior invention is installed on a hinged door having a multi-locking system.

FIG. 10A to 10C are cross-sectional views for explaining the improvement required when installing the auxiliary locking device for the hinged door according to the prior invention to the hinged door provided with the multi-locking system shown in FIG. 9A.

FIG. 11A to 11C are views showing a detailed configuration, an assembly state, and an operation state of a connecting plate, a base plate, and a cover plate constituting a preferred embodiment according to the present invention.

FIG. 12 is an operational state diagram including a state in which the cylinder pocket 1sa is installed in the pocket installation groove 233 of the cover plate 230.

FIG. 13 is an operation state diagram including a state in which the extended cover 240 is installed in the vertical direction of the cover plate 230.

FIG. 14 is a view showing the overall installation structure of a preferred embodiment according to the present invention, and FIG. 15A is a view showing a cross section taken along line A-A′ of FIG. 14 and FIG. 15B is a view showing a cross section taken along line B-B′ of FIG. 14.

FIG. 16 is an exploded perspective view of a preferred embodiment according to the present invention, and FIG. 17 is an operating state diagram showing the process of assembly and disassembly between the upper connecting plate 211 and the lower connecting plate 212 constituting the connecting plate in the preferred embodiment according to the present invention.

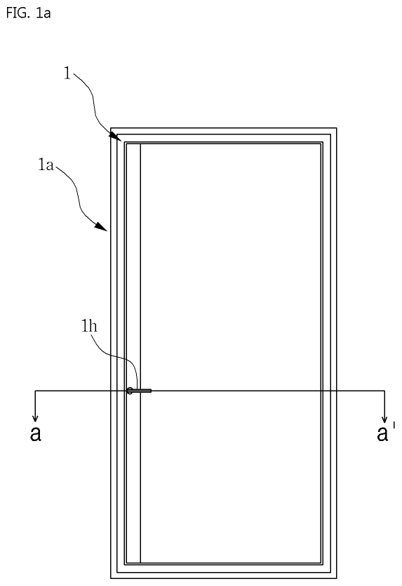

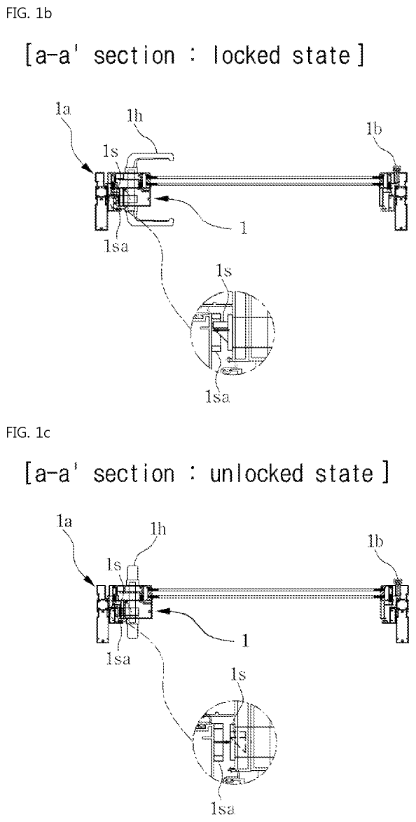

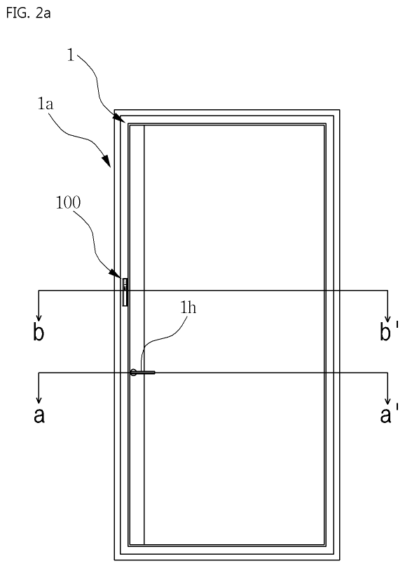

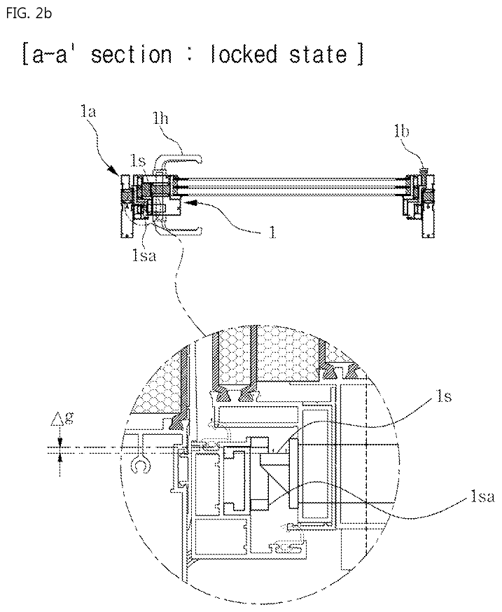

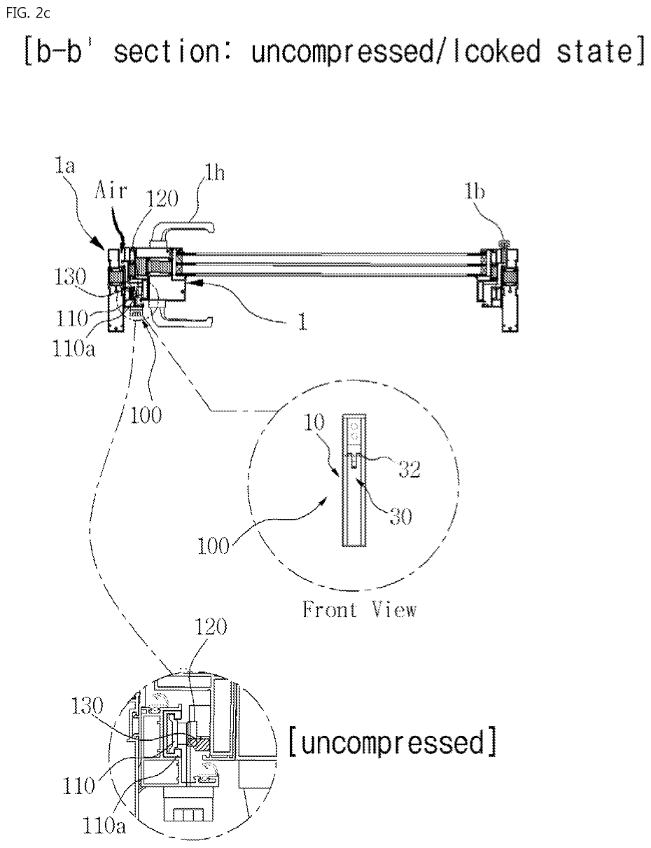

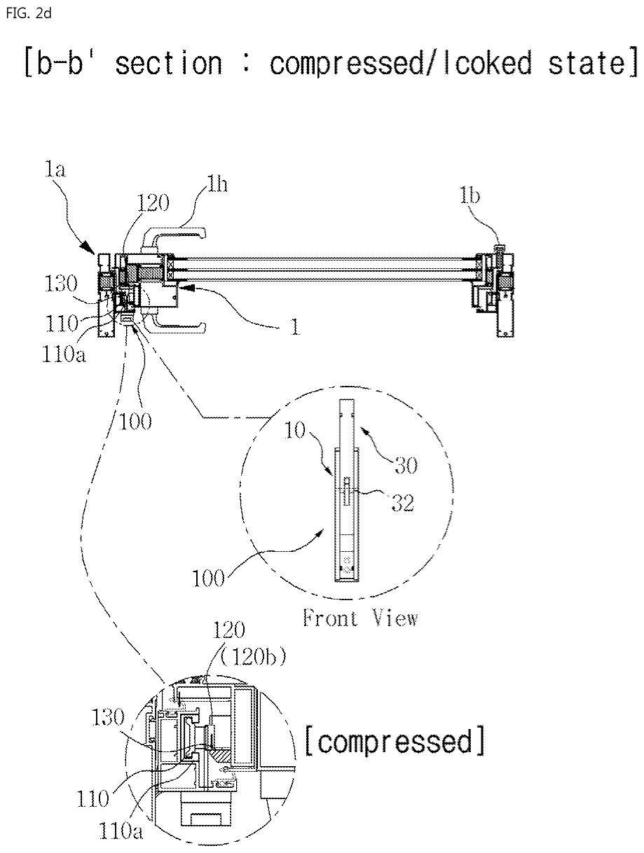

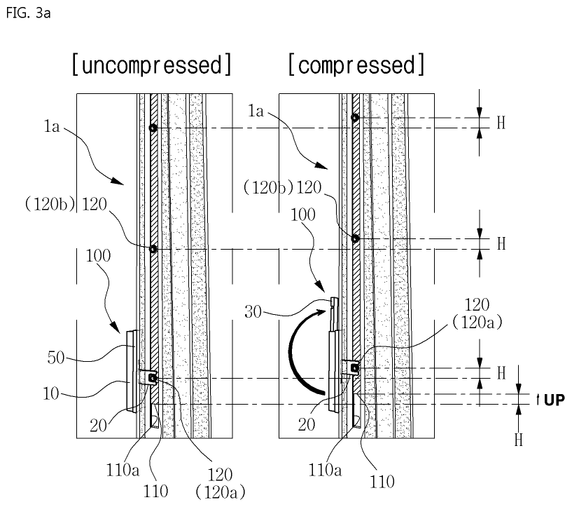

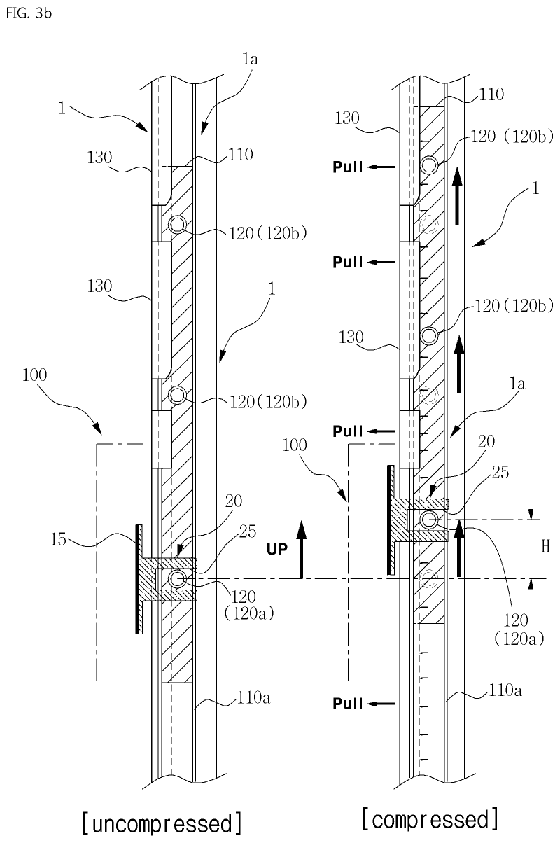

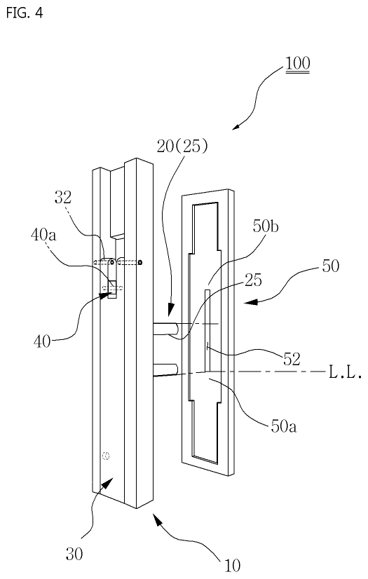

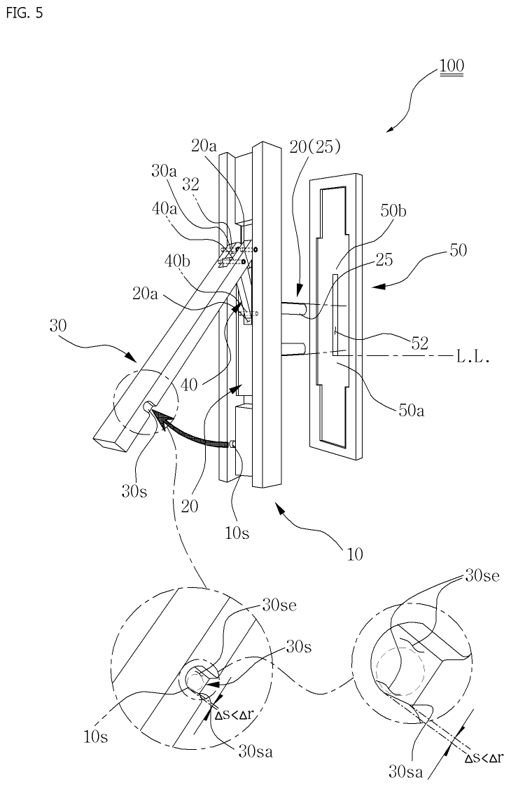

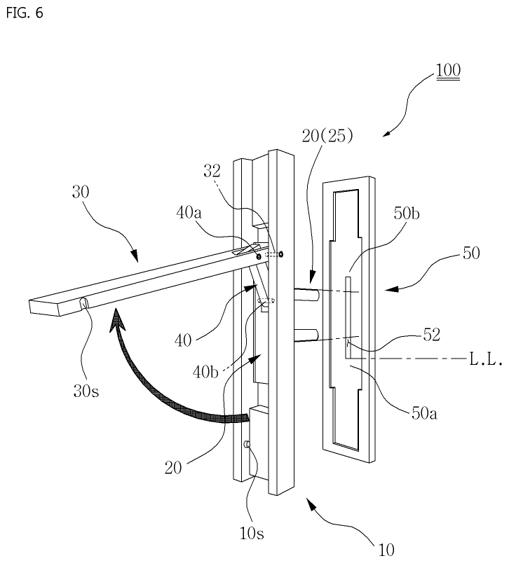

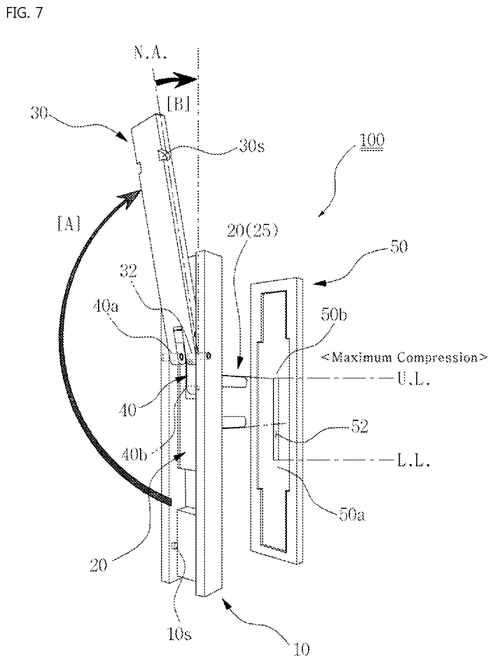

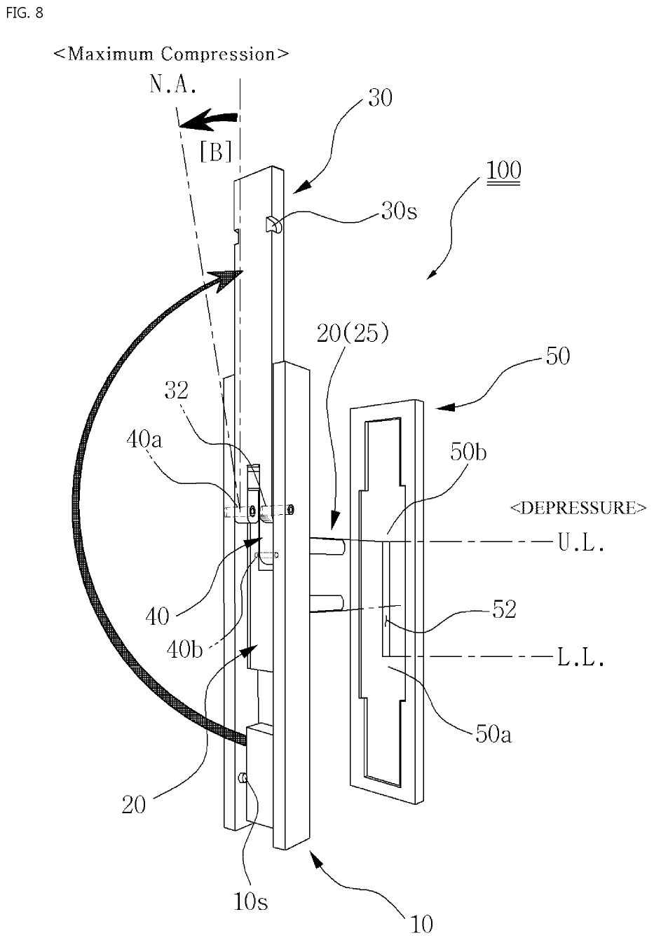

### BEST MODE OF THE INVENTION

Hereinafter, embodiments that are easily performed by those skilled in the art will be described in detail with reference to the accompanying drawings. However, the embodiments of the present invention may be achieved in several different forms and are not limited to the embodiments described herein.

### MODES OF THE INVENTION

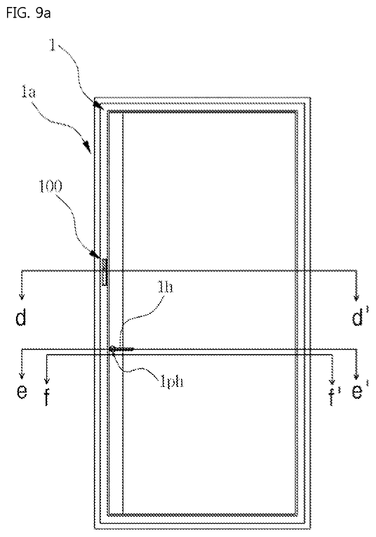

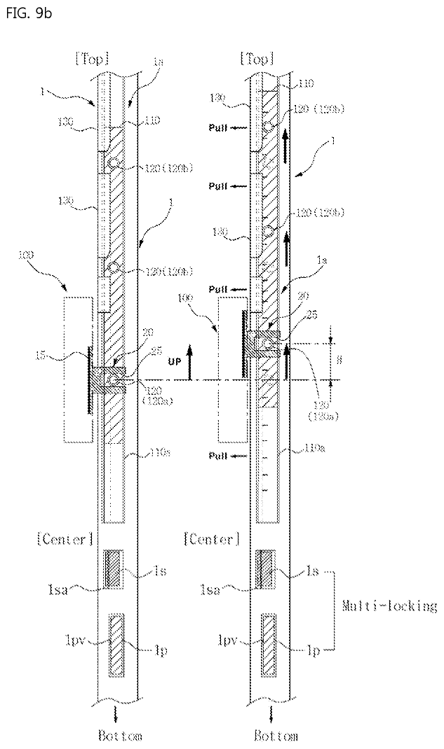

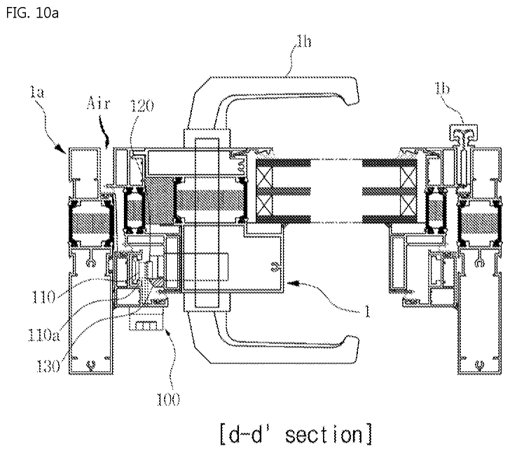

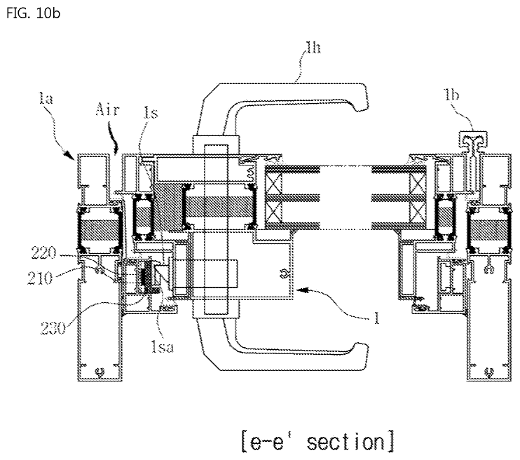

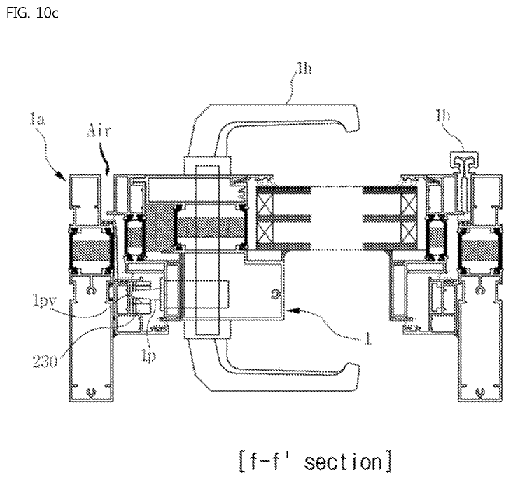

According to the present invention, as an opening and closing device for a hinged door installed on a door frame using a door hinge 1b installed on one side of a door frame 1a, there is provided an installation structure of an auxiliary locking device for a hinged door additionally provided in order to realize a close contact state to a door frame 1a of a hinged door 1 provided with two or more locking tools ‘1h, 1s, 1sa’, ‘1ph, 1p, 1pv’ as a main locking device for security, as shown in FIG. 9A to 10C, an example of an auxiliary locking device to which the present invention is applied, comprises;

a plurality of close contact guide plates 130 that are installed longitudinally and spaced apart from the rotating opening side of the hinged door 1;

a plurality of pressure rolls 120 provided longitudinally spaced apart from the door frame 1a side so that in a state in which the rotating opening side of the hinged door 1 is closed on the door frame 1a side, in a contact state with the close contact guide plates 130, the rotating opening side of the hinged door 1 is pulled toward the door frame 1a side, thereby implementing a compressed locked state, and so that in a non-contact state with the close contact guide plates 130, an uncompressed locked state of the rotating opening side of the hinged door 1 against the door frame 1a side is implemented;

a driving plate 110 installed in a sliding pocket 110a provided in a longitudinal direction on the door frame side so that the pressure rolls 120 can be installed to be slidably movable in a longitudinal direction from the side of the door frame 1a, and provided so that the pressure rolls 120 are spaced apart in the longitudinal direction on the front side; and

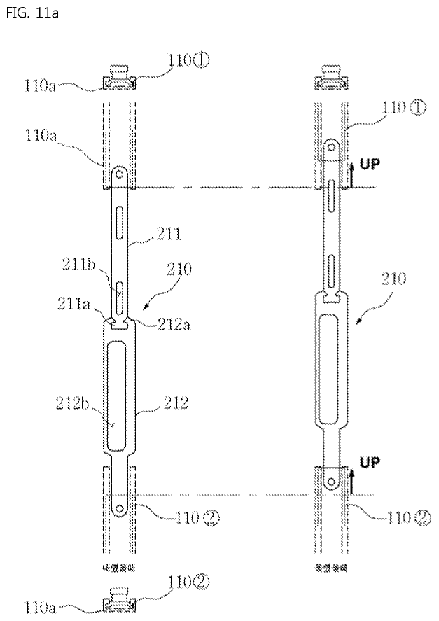

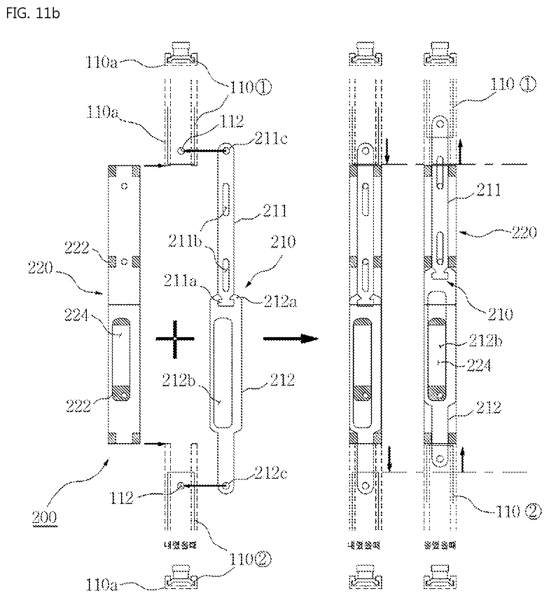

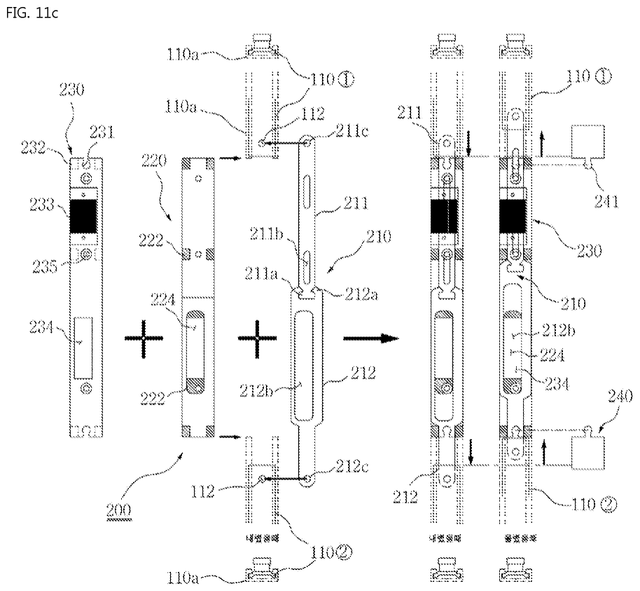

a switching device 100 installed in the door frame 1a so that the second pressure roll 120b switches between a contact compressed state position with the close contact guide plate 130 and a non-contact uncompressed state position through a longitudinal movement displacement, so that can induce a corresponding longitudinal movement displacement of the driving plate 110 by providing a longitudinal movement displacement by engaging with at least one first pressure roll 120a among the pressure rolls 120 installed on the driving plate 110, and so that can generate the longitudinal movement displacement of the remaining second pressure roll 120b induced by the longitudinal movement displacement of the drive plate 110;

wherein, an auxiliary locking device installation structure for a hinged door in which the auxiliary locking device is installed between the rotating opening side of the hinged door and the door frame side, as shown in FIG. 11A to 16, is characterized in that,

as an opening and closing device for a hinged door 1, the driving plate 110: 110\textcircled{1}, 110\textcircled{2} is respectively disposed in the upper section and in the lower section of the area in which the first locking tool 1h, 1s, 1sa and the second locking tool 1ph, 1p, 1pv are installed, which are provided as the main locking device for security between the rotating opening side of the hinged door 1 and the door frame 1a side, and sliding pockets 110a at the upper and lower portions are installed separately in the longitudinal direction on the side of the door frame 1a in order to accommodate the driving plates, respectively,

a connecting plate 210 is provided as a connecting means installed so as to reciprocate between the upper and lower sliding pockets 110a and interconnect the upper and lower drive plates 110\textcircled{1}, 110\textcircled{2} that are separately installed up and down, wherein the connecting plate 210 comprising an upper connecting plate 211 connected to the lower end of the upper driving plate 110\textcircled{1}, and a lower connecting plate 212 connected to the upper end of the lower driving plate 110\textcircled{2} and connected so that the upper connecting plate 211 is not separated in the longitudinal direction but can be separated only in the front-rear direction,

a base plate 220 is provided, wherein the base plate 220 being installed between the upper and lower sliding pockets 110a separated and separated to each other to support the bottom surface of the connecting plate 210 and to guide the vertical movement of the connecting plate 210, and

a cover plate 230 is provided on an upper surface of the base plate 220 to be spaced apart from each other by a height exceeding the thickness of the connecting plate 210 in order to form an operating space allowing the connecting plate 210 to move in the longitudinal direction,

wherein a pocket installation groove 233 in which a cylinder pocket 1sa accommodating a locking cylinder is constituting the first locking tool is installed is provided on the upper surface of the cover plate 230, and

wherein the cover plate 230 and the connecting plate 210 are provided with locking piston through holes 234, 212b, respectively, so that the lateral operating range of the locking piston 1p constituting the second locking tool can reach the base plate region.

Hereinafter, a detailed configuration and operation process of a preferred embodiment of the present invention will be described in more detail through the accompanying drawings.

FIG. 11A to 11C are detailed configurations of the connecting plate 210, the base plate 220, and the cover plate 230 constituting a preferred embodiment according to the present invention, as well as an assembly state and an operating state (up and down movement state, UP &amp; DOWN). First, as shown in FIG. 11A, the connecting plate 210 is installed to interconnect the upper driving plate 110\textcircled{1} and the lower driving plate 110\textcircled{2} which are separately installed up and down, and comprises an upper connecting plate 211 having a connecting pin 211c inserted into a connecting hole 112, a connecting pin 212c inserted and connected to the connecting hole 112 formed at the upper end of the lower driving plate 110\textcircled{2}, and the lower connecting plate 212 which is connected to the upper connecting plate 211 so as not to be separated in the longitudinal direction but only in the front-rear direction (refer to FIG. 17) from the upper connecting plate 211.

The connection state of the upper connecting plate 211 and the lower connecting plate 212 can be achieved by a fastening structure of the front and rear fitting method between a male fastener 211a of the lower end of the upper connecting plate 211 and a female fastener 212a of the lower connecting plate 212.

On the other hand, a fastening piece through-hole 211b is provided at a predetermined central position of the upper connecting plate 211, and a detailed structure and operation thereof will be described later. In addition, a locking piston through-hole 212b is provided at a predetermined central position of the lower connecting plate 212.

And, between the upper and lower sliding pockets 110a separated by spaced apart in the vertical direction in a corresponding region facing the locking cylinder is constituting the first locking tool and the locking piston 1p constituting the second locking tool, as shown in FIG. 11B, a base plate 220 is installed to support the bottom surface of the connecting plate 210 so as to guide the vertical movement of the connecting plate 210.

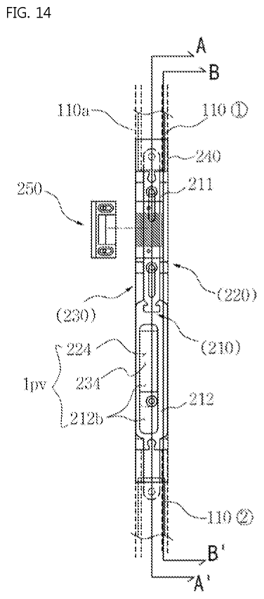

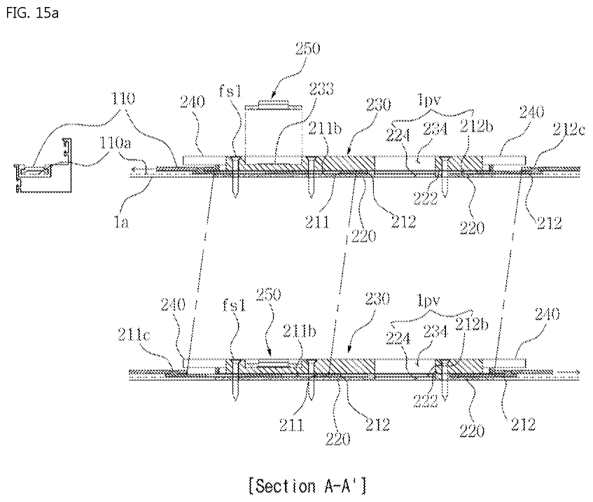

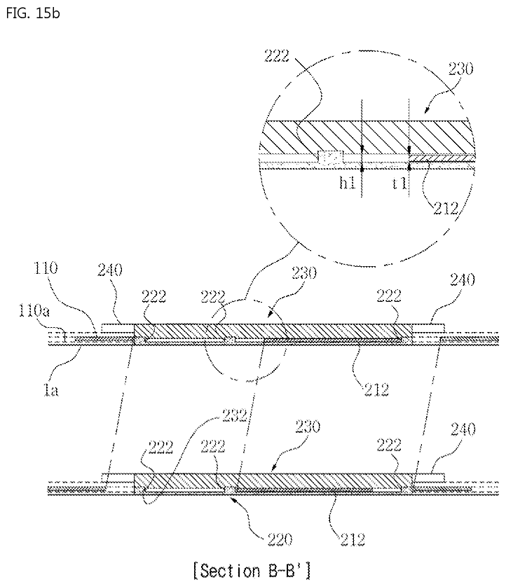

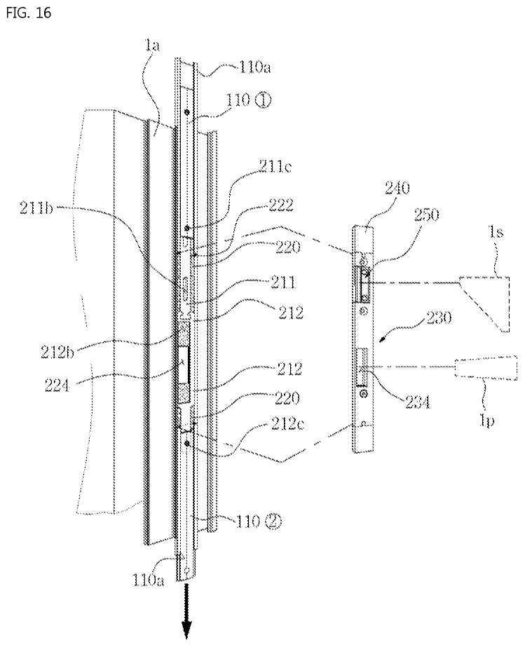

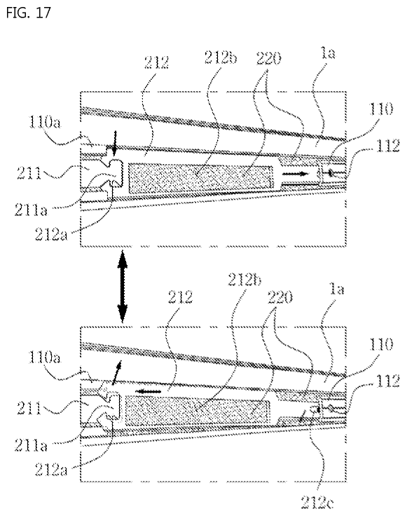

In addition, in order to form an operating space that enables the longitudinal movement of the connecting plate 210, as illustrated in the accompanying drawings FIG. 11c, the cover plate 230 is installed by being spaced apart from the upper surface of the base plate 220 by a height h1 or more (See FIG. 15B) that exceeds the thickness t1 of the connecting plate 210. In this way, the structure in which the cover plate 230 is spaced apart from the base plate 220 shown in FIG. 14, FIG. 15B showing a cross section taken along line B-B′ of FIG. 14, and FIG. 16, could be implemented through a spacer 222 provided to support a portion of the upper surface of the base plate 220 and a portion of the bottom surface of the cover plate 230. Here, as illustrated in FIG. 15B, the spacer 222 may be integrally protruded from the upper surface of the base plate 220, or alternatively, may be integrally protruded from the lower surface of the cover plate 230. In addition, a mounting groove 232 may be additionally provided on the corresponding surface (e.g. the lower surface of the cover plate 230 in FIGS. 11C and 15B) of the protrusion of the spacer 222.

In addition, a pocket installation groove 233 in which a cylinder pocket 1sa for accommodating the locking cylinder is constituting the first locking tool is fixedly installed is provided on the upper surface of the cover plate 230, and a locking piston through-hole 234 is also provided in the cover plate 230 at a position corresponding to the formation position of the locking piston through-hole 212b of the lower connecting plate 212 so that the lateral operating range of the locking piston 1p constituting the second locking tool can reach the base plate 220 region.

Further, the base plate 220 may also be provided with a locking piston through-hole 224 at a position corresponding to the provision position of the locking piston through-hole 212b of the lower connecting plate 212, whereby it is possible to achieve a more stable security structure by allowing the locking piston 1p constituting the second locking tool to be closer to the door frame 1a.

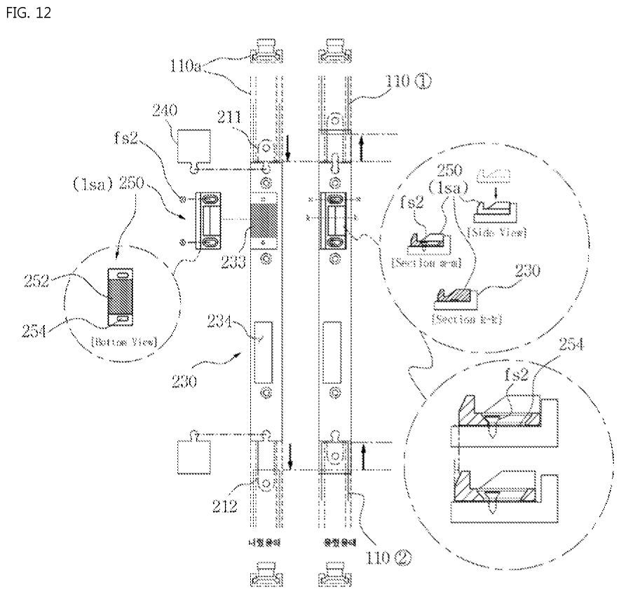

According to a preferred embodiment of the present invention, as shown in FIG. 12 and in the side view and enlarged cross-sectional view of the main part, the cylinder pocket 1sa (also marked with the drawing number ‘250’) is installed in the pocket installation groove 233 of the cover plate 230 after finding an appropriate location. For such function of adjusting the installation position of the cylinder pocket, a micro protrusion groove structure for determining the installation position is provided at the center of the pocket installation groove 233 of the cover plate 230, and a micro protrusion groove 252 structure for determining the installation position having a shape corresponding to the micro protrusion groove structure of the pocket installation groove 233 is provided at the bottom of the cylinder pocket 250. For the fixed installation of the cylinder pocket 250, fastening holes through which the fastening pieces fs2 are fastened are formed in the upper and lower portions of the pocket installation grooves 233. In addition, a through long hole 254 having a long hole shape is provided in the upper and lower portions of the cover plate 230 so that the fastening piece fs2 can be penetrated in a state where the through position is changed.

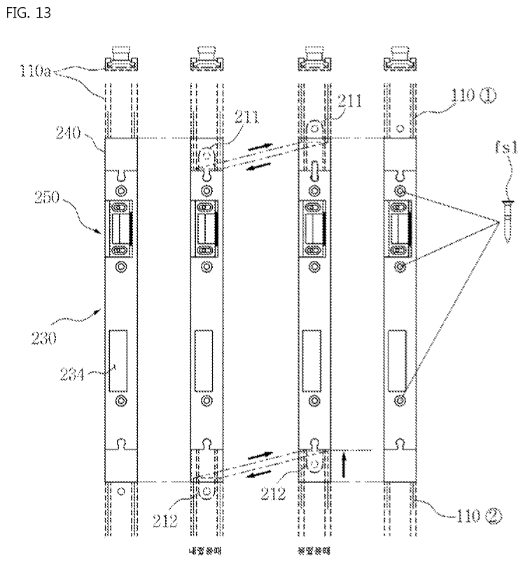

And, according to one embodiment of the present invention shown in FIGS. 12 and 13, the extension cover 240 is installed in the vertical direction of the cover plate 230 to provide a good finish in appearance.

FIG. 12 shows a state in which the cylinder pocket 250 is installed in the pocket installation groove 233 of the cover plate 230 and is fixed by the fastening piece fs2, but FIGS. 13 and 15A (cross-sectional view along A-A′ line of FIG. 14) show a structure in which the cover plate 230 is rigidly fixed to the door frame 1a by a fastening piece fs1 penetrating the cover plate 230 and the base plate 220. In this way, so that the movement of the connecting plate 210 in the vertical direction is not disturbed by the fastening piece fs1 that is fastened through the cover plate 230 and the base plate 220, a fastening piece through-hole 211b having a long hole shape (up and down movement range length of a long hole) is provided at a predetermined central position of the upper connecting plate 211.

FIG. 14 shows the overall installation structure of a preferred embodiment according to the present invention, and the locking piston through-hole 234 of the cover plate 230, which is provided so that the lateral operating range of the locking piston 1p constituting the second locking tool described above can reach the base plate 220 region. The through-fastening operation state of the locking piston 1p is confirmed through FIG. 15A showing a cross section taken along line A-A′ of FIG. 14 and FIG. 16 showing an exploded state of a preferred embodiment according to the present invention.

According to a preferred embodiment of the present invention, as described above, the upper connecting plate 211 connected to the lower end of the upper driving plate 110\textcircled{1} and the lower connecting plate 212 connected to the upper end of the lower driving plate 110\textcircled{2} have a structure that is connected so that it is not separated from each other in the vertical direction but can be separated only in the front and rear directions. In the case of using an integrated connecting plate between the lower end of the upper drive plate 110\textcircled{1} and the upper end of the lower drive plate 110\textcircled{2} with a certain distance, this separation structure in the front-rear direction was adopted so that it can be separated only in the front and rear directions in consideration of the difficulty of performing interconnection work of integrated plate at the door installation construction site.

For example, as shown in the FIG. 17 (upper assembly; lower disassembly), looking at the disassembly process of the lower connecting plate 212 connected to the upper end of the lower driving plate 110\textcircled{2}, by moving the upper connecting plate 211 and the lower connecting plate 212 constituting the connecting plate 210 in either direction (upward movement in the drawing), by separating the fitting state of the mail fastener 211a of the lower end of the upper connecting plate 211 and the female fastener 212a of the lower connecting plate 212 constituting the interconnection in the front and rear directions (Raising the front of the female fastener 212a of the lower connecting plate 212), the rearward movement of the connection pin 212c at the lower end of the lower connecting plate 212 is induced in the other direction. Thereby, the connection pin 212c at the lower end of the lower connecting plate 212 is removed from the connection hole 112 formed at the upper end of the lower driving plate 110\textcircled{2} so that the disassembly operation of the lower connecting plate 212 is completed. At this time, the rearward movement of the connection pin 212c at the lower end of the lower connecting plate 212 is more easily performed through a free space provided by the locking piston through-hole 224 of the base plate 220. This makes it possible to carry out the sequential disassembly of the remaining parts, and the assembly can be carried out simply by an operation in the opposite direction to the disassembly described previously.

In the above, while describing in detail a preferred embodiment of the present invention, directional terms “upward” and “downward” have been used in describing the operating directions of the upper driving plate 110\textcircled{1} and the lower driving plate 110\textcircled{2}, but it is assumed that the device according to the present invention is installed in the door frame in the direction shown in the drawings. When the locking device according to the present invention is installed in a different direction, upward and downward directions may be reversed, or the direction may be leftward and rightward directions. Therefore, it should be understood that the directional terms are not to be construed as limiting the scope of the present invention, and various modifications and improvements by those skilled in the art using the basic concept of the present invention defined in the following claims are also within the scope of the present invention.

1-9. (canceled)

10. A structure of auxiliary locking device of a hinged door, characterized in that as an opening and closing device for a hinged door 1, the driving plate 110: 110\textcircled{1}, 110\textcircled{2} upwardly and downwardly moved by a switching device 100 constituting the auxiliary locking device of a hinged door, is respectively disposed in the upper section and in the lower section of the area in which the first locking tool 1h, 1s, 1sa and the second locking tool 1ph, 1p, 1pv are installed, which are provided as the main locking device for security between the rotating opening side of the hinged door 1 and the door frame 1a side, and sliding pockets 110a at the upper and lower portions are installed separately in the longitudinal direction on the side of the door frame 1a in order to accommodate the driving plates, respectively,
a connecting plate 210 is provided as a connecting means installed so as to reciprocate between the upper and lower sliding pockets 110a and interconnect the upper and lower drive plates 110\textcircled{1}, 110\textcircled{2} that are separately installed up and down, wherein the connecting plate 210 comprising an upper connecting plate 211 connected to the lower end of the upper driving plate 110\textcircled{1}, and a lower connecting plate 212 connected to the upper end of the lower driving plate 110\textcircled{2} and connected so that the upper connecting plate 211 is not separated in the longitudinal direction but can be separated only in the front-rear direction,
a base plate 220 is provided, wherein the base plate 220 being installed between the upper and lower sliding pockets 110a separated and separated to each other to support the bottom surface of the connecting plate 210 and to guide the vertical movement of the connecting plate 210, and
a cover plate 230 is provided on an upper surface of the base plate 220 to be spaced apart from each other by a height exceeding the thickness of the connecting plate 210 in order to form an operating space allowing the connecting plate 210 to move in the longitudinal direction,
wherein a pocket installation groove 233 in which a cylinder pocket 1sa accommodating a locking cylinder is constituting the first locking tool is installed is provided on the upper surface of the cover plate 230, and
wherein the cover plate 230 and the connecting plate 210 are provided with locking piston through holes 234, 212b, respectively, so that the lateral operating range of the locking piston 1p constituting the second locking tool can reach the base plate region.

11. The structure of auxiliary locking device of a hinged door of claim 10, wherein the auxiliary locking device for a hinged door including the switching device 100 is additionally provided in order to realize a close contact state to a door frame 1a of a hinged door 1 provided with two or more locking tools ‘1h, 1s, 1sa’, ‘1ph, 1p, 1pv’ as a main locking device for security, the auxiliary locking device of a hinged door comprises;
a plurality of close contact guide plates 130 that are installed longitudinally and spaced apart from the rotating opening side of the hinged door 1;
a plurality of pressure rolls 120 provided longitudinally spaced apart from the door frame 1a side so that in a state in which the rotating opening side of the hinged door 1 is closed on the door frame 1a side, in a contact state with the close contact guide plates 130, the rotating opening side of the hinged door 1 is pulled toward the door frame 1a side, thereby implementing a compressed locked state, and so that in a non-contact state with the close contact guide plates 130, a uncompressed locked state of the rotating opening side of the hinged door 1 against the door frame 1a side is implemented;
a driving plate 110 installed in a sliding pocket 110a provided in a longitudinal direction on the door frame side so that the pressure rolls 120 can be installed to be slidably movable in a longitudinal direction from the side of the door frame 1a, and provided so that the pressure rolls 120 are spaced apart in the longitudinal direction on the front side; and
a switching device 100 installed in the door frame 1a so that the second pressure roll 120b switches between a contact compressed state position with the close contact guide plate 130 and a non-contact uncompressed state position through a longitudinal movement displacement, so that can induce a corresponding longitudinal movement displacement of the driving plate 110 by providing a longitudinal movement displacement by engaging with at least one first pressure roll 120a among the pressure rolls 120 installed on the driving plate 110, and so that can generate the longitudinal movement displacement of the remaining second pressure roll 120b induced by the longitudinal movement displacement of the drive plate 110.

12. The structure of auxiliary locking device of a hinged door of claim 10, wherein the connecting plate 210 installed to interconnect the upper driving plate 110\textcircled{1} and the lower driving plate 110\textcircled{2} installed separately in the vertical direction, in order to be connected so that the upper connecting plate 211 and the lower connecting plate 212 are not separated from each other in the longitudinal direction but can be separated only in the front and rear direction, is characterized in that the lower end of the upper connecting plate 211 includes a male fastener 211a, and the upper end of the lower connecting plate 212 includes a female fastener 212a that is fastened in a front-rear direction fitting method.

13. The structure of auxiliary locking device of a hinged door of claim 12, characterized in that the cover plate 230 is rigidly fixed to the door frame 1a by a fastening piece fs1 penetrating the cover plate 230 and the base plate 220, and so that the movement of the connecting plate 210 in the vertical direction is not disturbed by the fastening piece fs1 that is fastened through the cover plate 230 and the base plate 220, a fastening piece through-hole 211b having a long hole shape is provided at a predetermined central position of the upper connecting plate 211, and a locking piston through-hole 212b is provided at a predetermined central position of the lower connecting plate 212.

14. The structure of auxiliary locking device of a hinged door of claim 10, wherein the structure in which the cover plate 230 is spaced apart from the base plate 220, is implemented through a spacer 222 provided to support a portion of the upper surface of the base plate 220 and a portion of the bottom surface of the cover plate 230.

15. The structure of auxiliary locking device of a hinged door of claim 14, wherein the spacer 222 is integrally protruded from the upper surface of the base plate 220, and a mounting groove is additionally provided on the lower surface of the cover plate 230.

16. The structure of auxiliary locking device of a hinged door of claim 13, wherein a pocket installation groove 233 in which a cylinder pocket 1sa for accommodating the locking cylinder is constituting the first locking tool is fixedly installed is provided on the upper surface of the cover plate 230, and
a locking piston through-hole 234 is also provided in the cover plate 230 at a position corresponding to the formation position of the locking piston through-hole 212b of the lower connecting plate 212 so that the lateral operating range of the locking piston 1p constituting the second locking tool can reach the base plate 220 region.

17. The structure of auxiliary locking device of a hinged door of claim 16, wherein the base plate 220 is provided with a locking piston through-hole 224 at a position corresponding to the provision position of the locking piston through-hole 212b of the lower connecting plate 212.

18. The structure of auxiliary locking device of a hinged door of claim 11, wherein the connecting plate 210 installed to interconnect the upper driving plate 110\textcircled{1} and the lower driving plate 110\textcircled{2} installed separately in the vertical direction, in order to be connected so that the upper connecting plate 211 and the lower connecting plate 212 are not separated from each other in the longitudinal direction but can be separated only in the front and rear direction, is characterized in that the lower end of the upper connecting plate 211 includes a male fastener 211a, and the upper end of the lower connecting plate 212 includes a female fastener 212a that is fastened in a front-rear direction fitting method.

19. The structure of auxiliary locking device of a hinged door of claim 18, characterized in that the cover plate 230 is rigidly fixed to the door frame 1a by a fastening piece fs1 penetrating the cover plate 230 and the base plate 220, and so that the movement of the connecting plate 210 in the vertical direction is not disturbed by the fastening piece fs1 that is fastened through the cover plate 230 and the base plate 220, a fastening piece through-hole 211b having a long hole shape is provided at a predetermined central position of the upper connecting plate 211, and a locking piston through-hole 212b is provided at a predetermined central position of the lower connecting plate 212.

20. The structure of auxiliary locking device of a hinged door of claim 19, wherein a pocket installation groove 233 in which a cylinder pocket 1sa for accommodating the locking cylinder is constituting the first locking tool is fixedly installed is provided on the upper surface of the cover plate 230, and
a locking piston through-hole 234 is also provided in the cover plate 230 at a position corresponding to the formation position of the locking piston through-hole 212b of the lower connecting plate 212 so that the lateral operating range of the locking piston 1p constituting the second locking tool can reach the base plate 220 region.

21. The structure of auxiliary locking device of a hinged door of claim 20, wherein the base plate 220 is provided with a locking piston through-hole 224 at a position corresponding to the provision position of the locking piston through-hole 212b of the lower connecting plate 212.

22. The structure of auxiliary locking device of a hinged door of claim 11, wherein the structure in which the cover plate 230 is spaced apart from the base plate 220, is implemented through a spacer 222 provided to support a portion of the upper surface of the base plate 220 and a portion of the bottom surface of the cover plate 230.

23. The structure of auxiliary locking device of a hinged door of claim 22, wherein the spacer 222 is integrally protruded from the upper surface of the base plate 220, and a mounting groove is additionally provided on the lower surface of the cover plate 230.

24. The structure of auxiliary locking device of a hinged door of claim 13, wherein a pocket installation groove 233 in which a cylinder pocket 1sa for accommodating the locking cylinder 1s constituting the first locking tool is fixedly installed is provided on the upper surface of the cover plate 230, and
a locking piston through-hole 234 is also provided in the cover plate 230 at a position corresponding to the formation position of the locking piston through-hole 212b of the lower connecting plate 212 so that the lateral operating range of the locking piston 1p constituting the second locking tool can reach the base plate 220 region.

25. The structure of auxiliary locking device of a hinged door of claim 16, wherein the base plate 220 is provided with a locking piston through-hole 224 at a position corresponding to the provision position of the locking piston through-hole 212b of the lower connecting plate 212.
